(19) United States
(12) Patent Application Publication
(10) Pub. No.: US 2005/0194105 A1
(43) Pub. Date: Sep. 8, 2005

(54) Windable curtain assembly for hiding the bottom of a raised patio construction

(76) Inventor: Jean-Robert Tremblay, St-Jerome (CA)

Correspondence Address: JOHN S. PRATT, ESQ;KILPATRICK STOCKTON, LLP, 1100 PEACHTREE STREET, ATLANTA, GA, 30309, US

(21) Appl. No.: 10/971,927

(22) Filed: Oct. 22, 2004

(30) Foreign Application Priority Data
Oct. 24, 2003 (CA) 2,446,650

(51) Int. Cl. E06B 9/08

(52) U.S. Cl. 160/133

(57) ABSTRACT

A windable curtain assembly for hiding the bottom of a raised patio construction is disclosed. The curtain assembly comprises a curtain including a series of laths spaced apart from each other, and at least two cords interconnecting the laths together in a parallel relationship. The assembly further comprises a connector to hang the curtain to the raised dwelling construction, whereby the curtain is fully extendable under the dwelling between a fully extended state and an upwardly wound state to provide access to an area located below the raised dwelling.

### FIELD OF THE INVENTION

The present invention relates generally to the field of patio construction, raised dwellings and the like. More particularly, it concerns a windable curtain assembly for hiding the bottom of a raised patio construction or of any raised dwelling.

### BACKGROUND

Generally, persons having a wooden or concrete raised patio construction are storing various articles in a space located under the patio, such as fire logs, a lawnmower or other articles used for landscaping. Easy access to that space is thus often needed. However, restricting access to that space to kids and animals might be desired for security reasons. Consequently, most of those storage spaces located under the patio constructions are surrounded by wooden or PVC trellises.

These wooden or PVC trellises are also used for privacy. They are not only used to hide what is stored under the patios, but also to contribute to the landscaping of a house.

One way to fix the trellises around the storage space is to insert wooden or PVC peripheral tracks around the trellises and then to fasten these tracks to peripheral framing members of the patio with nails or screws.

The fixation of such trellises around the storage space is not given to everyone. Abilities and experience in the construction field are often needed.

Unfortunately, those trellises do not entirely fulfill their role of providing easy access to the storage space. In fact, most of the time, a trellis section must be completely removed in order for a person to gain access to an article under the patio. Depending on how the trellises are fixed to the patio, it often requires tools to unfasten the trellises, which might be very inconvenient when rapid access to an article is needed.

Also known in the prior art, there is U.S. Pat. No. 6,339,904 which discloses a skirt for a raised dwelling for restricting movement of air thereunder. The skirt described therein includes a panel which is corrugated such that pleat folds are defined. The pleat folds have ridges and valley lines oriented generally parallel to the top edge of the panel. The skirt further comprises a plurality of rods, each extending through a set of apertures provided in the panel along a line oriented generally perpendicular to the top and bottom edges of the panel. Each of the rods has a pointed end removably insertable in the ground.

The Applicant is also aware of U.S. Pat. No. 2,961,255 which discloses a trailer skirt for closing the open space between the sills of an immobilized house trailer in the ground. The trailer skirt described therein is mounted on a spring roller enclosed in a housing that may be permanently attached or may be an integral part of the trailer body structure.

Also known in the related prior art are the following documents: U.S. Pat. No. 4,240,490; U.S. Pat. No. 4,799,524; U.S. Pat. No. 4,807,684; U.S. Pat. No. 4,825,921; U.S. Pat. No. 5,547,009; U.S. Pat. No. 6,138,739; U.S. Pat. No. 6,143,392; U.S. Pat. No. 6,176,050; U.S. Pat. No. 6,216,399; U.S. Pat. No. 6,536,503; and U.S. Pat. No. D440,095.

### SUMMARY OF THE INVENTION

An object of the present invention is to provide a windable curtain assembly for easy access to a storage space under a raised dwelling.

Another object of the present invention is to provide such a windable curtain assembly that is easy to install and that does not require abilities and experience in the construction field.

According to the present invention, these objects are achieved with a windable curtain assembly for a raised dwelling. The curtain assembly comprises a curtain including a series of laths spaced apart from each other, and at least two cords interconnecting the laths together in a parallel relationship. The assembly further comprises a connector to hang the curtain to the raised dwelling construction, whereby the curtain is windable under the dwelling between a fully extended state and an upwardly wound state to provide access to an area located below the raised dwelling.

By raised dwelling, it is meant any raised construction or place to live in, as for example, a raised patio construction, a trailer or a house built on piles.

As can be appreciated, the curtain assembly according to the invention is easy to install and can be installed by any person non-skilled in the construction field. It also does not require particular maintenance, since it does not include complex mechanical parts. Articles stored under a raised patio or any other raised dwelling are well hidden from view and protected from bad weather.

Preferably, the connector comprises at least two J-shaped brackets each having a vertical arm adapted to be connected to the dwelling and a second arm projecting horizontally from the first arm for supporting an uppermost lath of the series of laths.

Also preferably, each of the laths has two opposite ends and the assembly comprises at least one pair of U-shaped brackets including a first and a second U-shaped brackets for attachment respectively to a first and a second vertical support posts supporting the dwelling construction. The ends of any one of the laths is insertable in the U-shaped brackets to keep the curtain in place while it is in the fully extended state.

Still preferably, the assembly further comprises an additional curtain, and at least one C-shaped bracket to interconnect end to end the second curtain to the first curtain.

Preferably, the laths are any planks or thin strips of a material selected from the group consisting of wood, plastic, and metal, and the cords are stapled or glued to a back side of the laths.

### BRIEF DESCRIPTION OF A PREFERRED EMBODIMENT OF THE INVENTION

These and other objects and advantages of the invention will become apparent upon reading the detailed description and upon referring to the drawings in which:

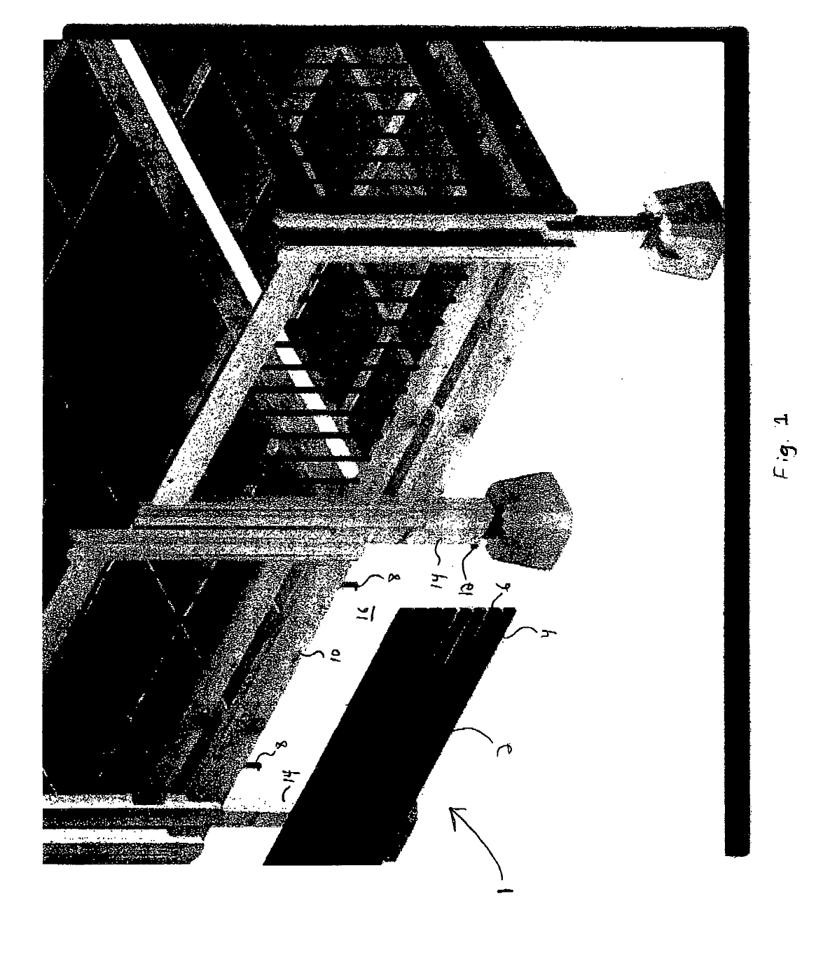

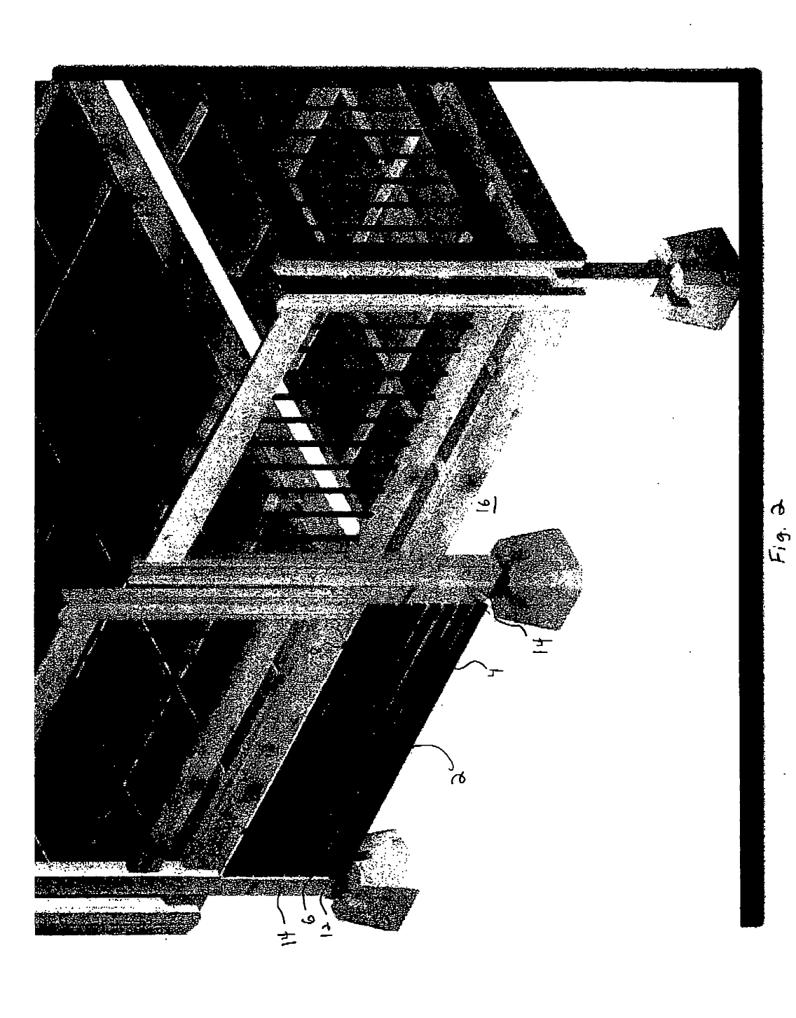

FIGS. 1 and 2 show the sequence of steps for assembling a windable curtain according to a first preferred embodiment of the invention on a patio.

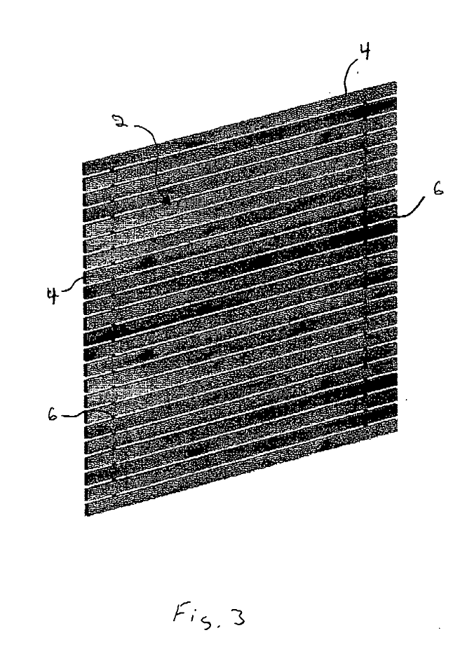

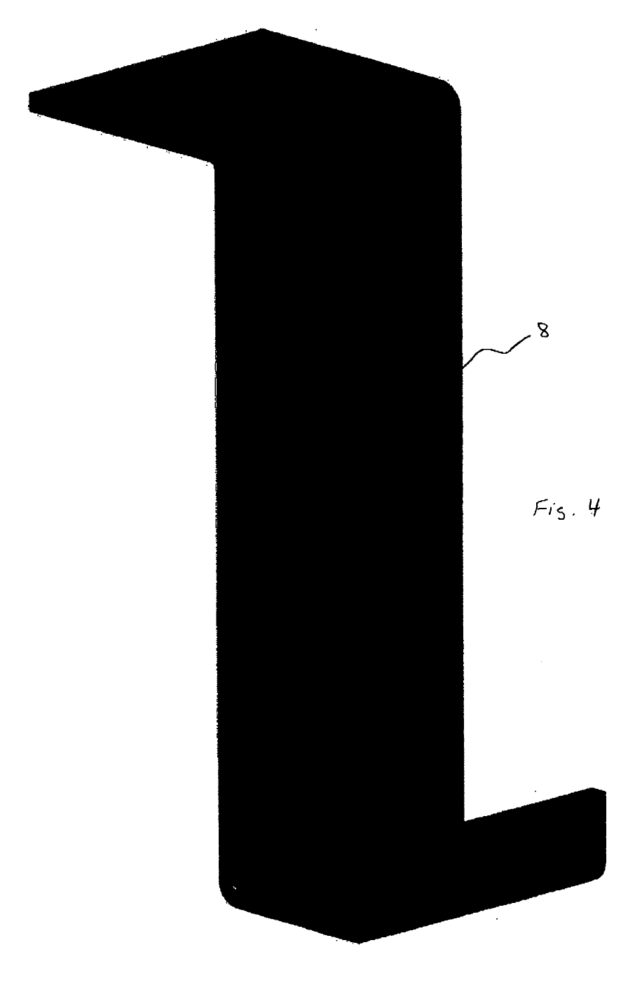

FIG. 3 is a perspective view of a curtain according to another preferred embodiment of the invention.

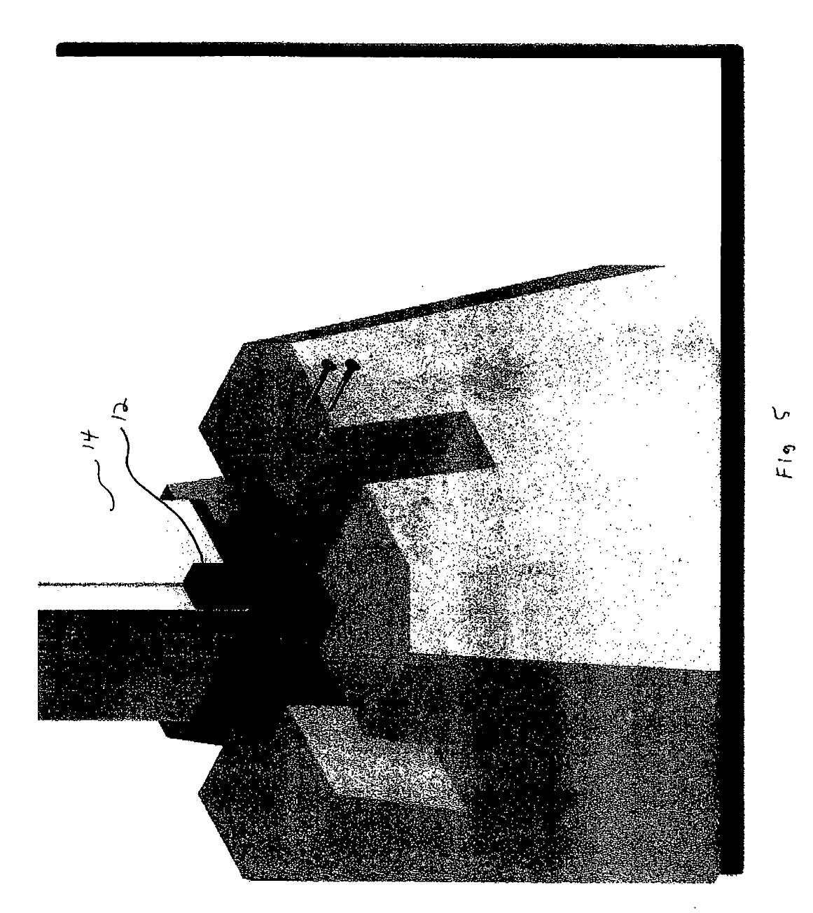

FIGS. 4, 5 and 6 show various support brackets used for mounting the curtain to a patio.

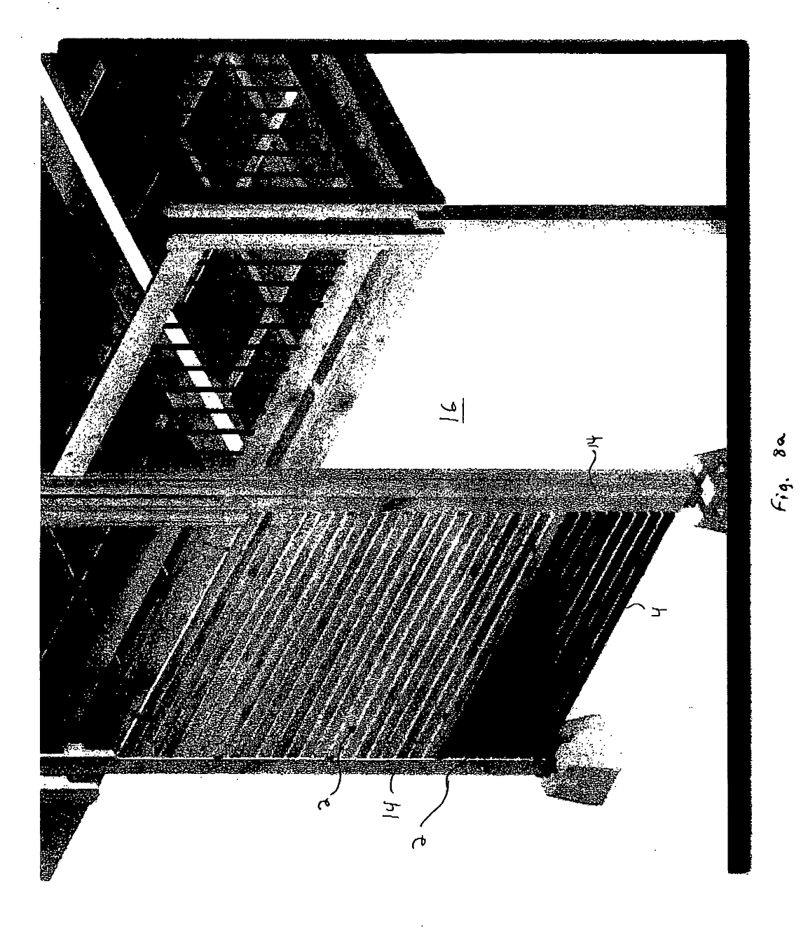

FIG. 7 is a perspective view of the curtain of FIG. 1 in a wound up position.

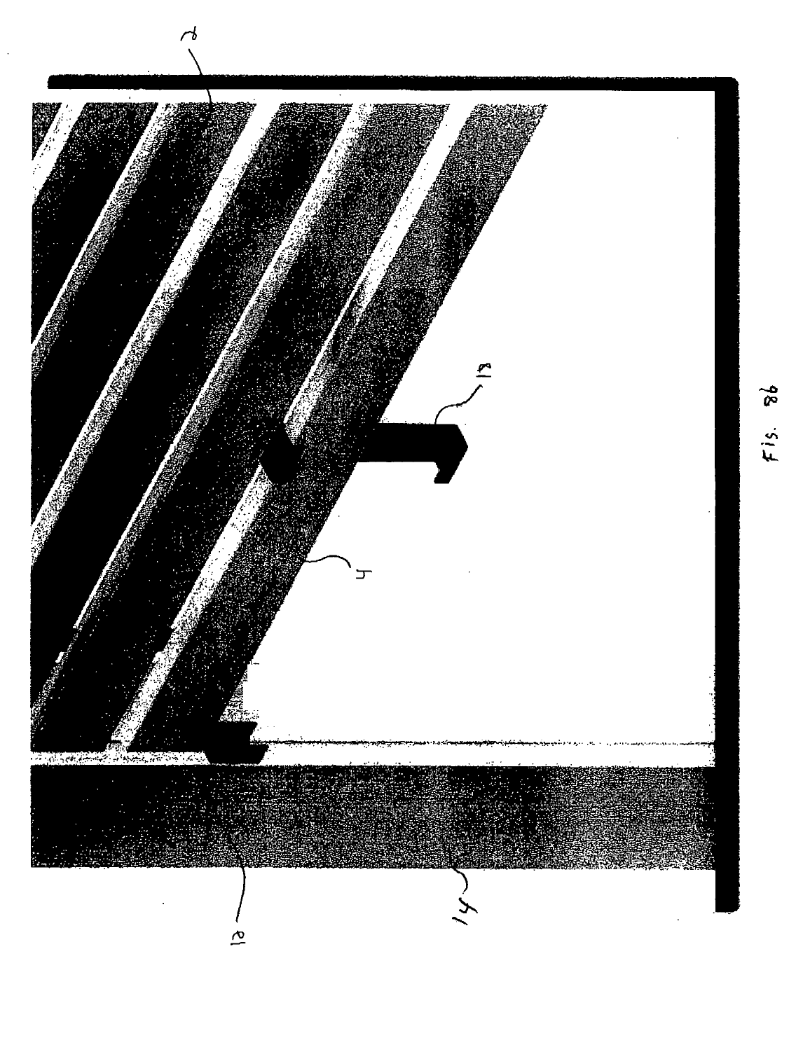

FIG. 8a shows a curtain according to a further embodiment of the present invention composed of more than one curtain section in an end to end interconnection relationship.

FIG. 8b shows a bracket used to interconnect the two curtain sections of the curtain of FIG. 8a.

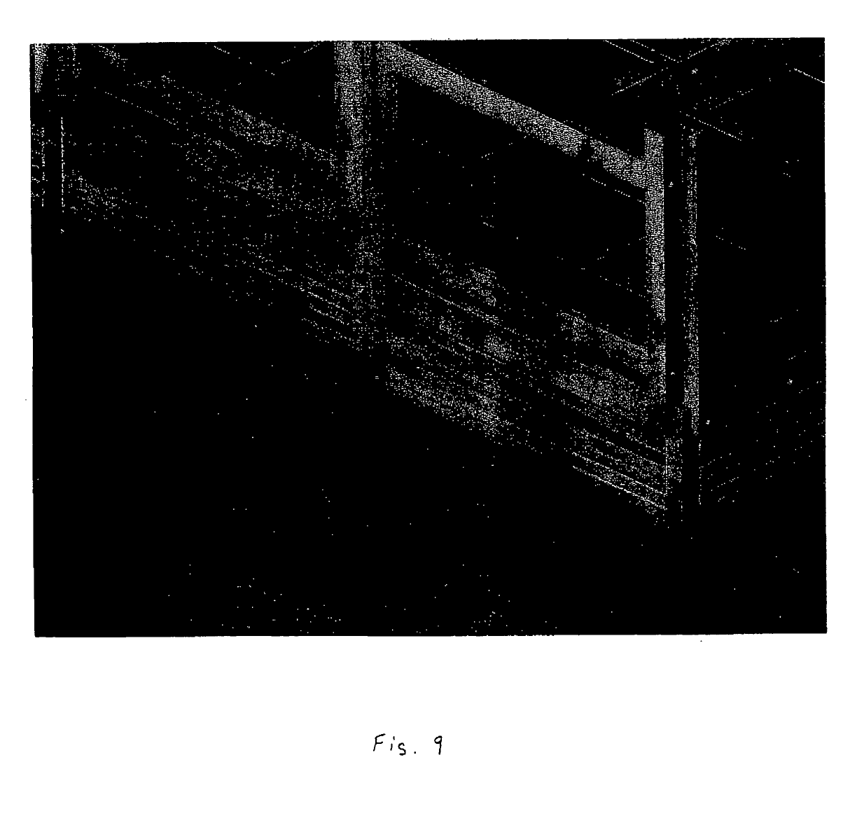

FIG. 9 is a perspective view of a raised patio equipped with windable curtain assemblies according to the present invention.

### DETAILED DESCRIPTION OF PREFERRED EMBODIMENTS OF THE INVENTION

Referring to FIGS. 1 and 2, a windable curtain assembly 1 according to a preferred embodiment of the present invention is made of a curtain 2 and support brackets 8, 12. The curtain 2 has a plurality of laths 4 of wood, plastic or metal spaced apart from each other. The laths 4 are interconnected by strips of flexible material 6, such as nylon strips. These strips of flexible material 6 provide flexibility to the curtain 2 and some mobility between the laths 4. As shown in FIG. 2, the windable curtain is hung to the bottom of the patio by the support brackets 8. The support brackets 8 are keeping the curtain in place while it is fully extended.

By strips of flexible material, it is meant any cord used to bind, tie, connect, or support, that is to say any rope, strap or long, narrow strip of pliant material.

Referring to FIG. 3, two strips of the flexible material 6 are fixed to the laths 4. More strips of flexible material 6 could also be conveniently used for longer laths 4. The strips of flexible material 6 may be stapled or glued to a back side of the laths 4 or fixed to them in any other suitable manner.

Preferably, the laths 4 are made of wood, but they could also be made of other materials, such as PVC.

Referring also to FIG. 4, the support brackets 8 to hang the curtain 2 may be advantageously flanged J-shaped brackets 8. These J-shaped brackets 8 are screwed under a side framing member 10 of the patio. A lath 4, preferably located at the top end of the curtain 2, is inserted within the J-shaped bracket 8 for hanging the curtain 2 in a fully extended position. The lath 4 can be easily removed from the J-shaped brackets 8.

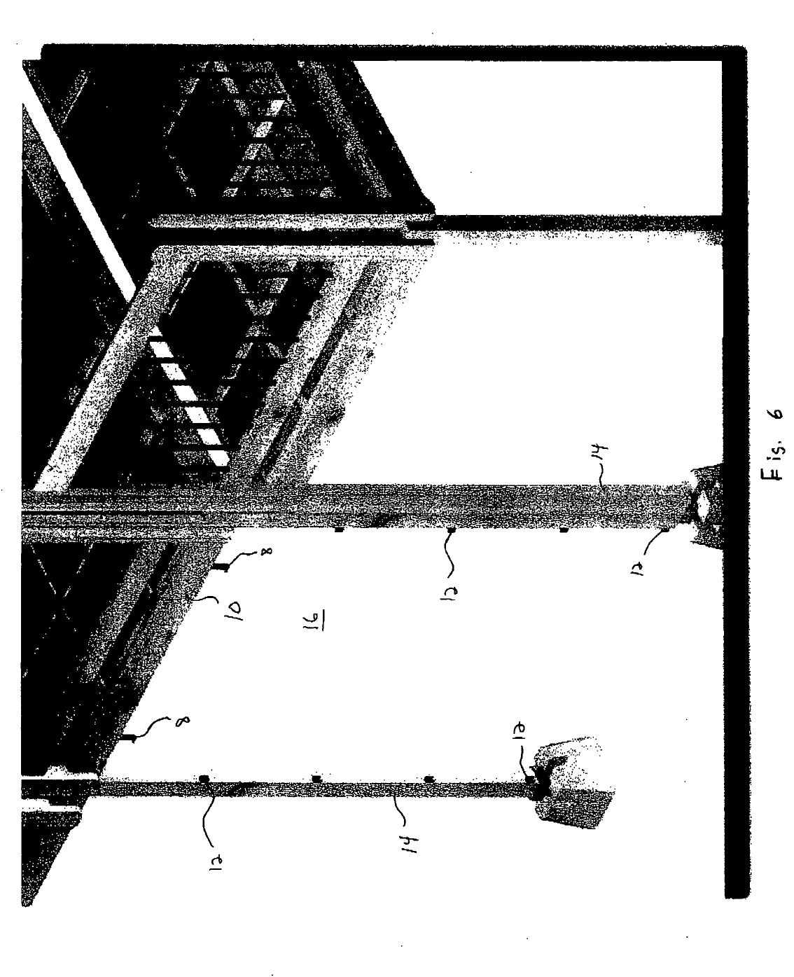

Referring now to FIG. 5, U-shaped brackets 12 are screwed to support posts 14 for keeping the curtain 2 in place while it is fully extended. When the curtain 2 is mounted on the J-shaped brackets 8, both ends of at least one lath 4, located preferably at the bottom end of the curtain, are slid within the U-shaped brackets 12 to prevent the curtain 2 from swinging during wind time or to be easily wound up by a child or an animal wishing to gain access to a space 16 under the patio.

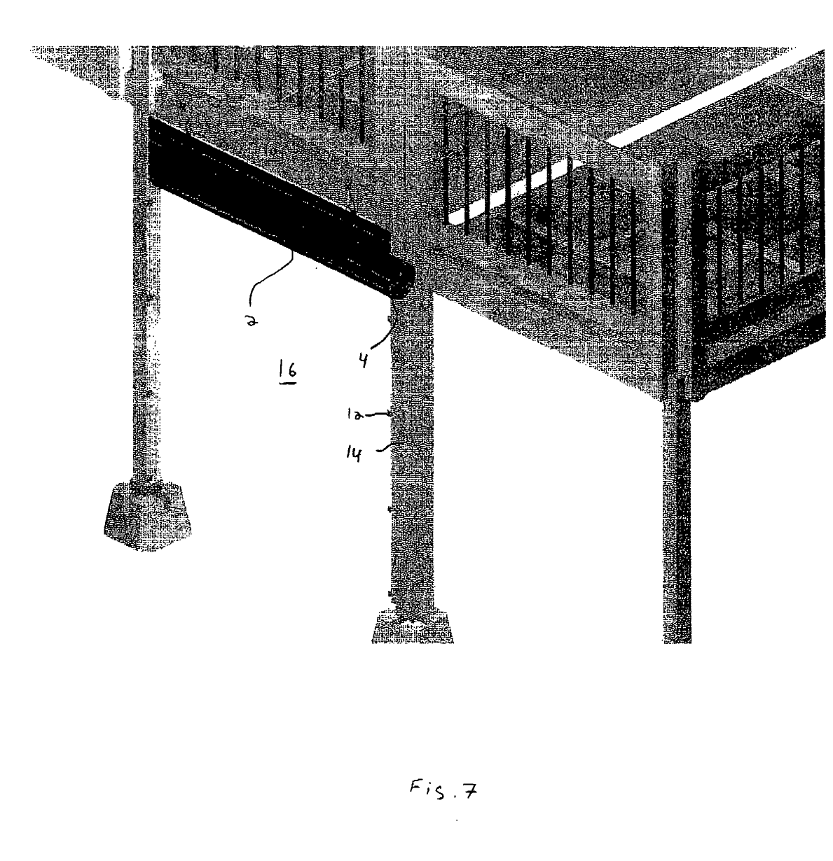

Referring to FIG. 6, the similar U-shaped brackets 12 may be distributed over the length of the support posts 14 to provide better support to the curtain 2 along its length.

FIG. 7 illustrates the curtain 2 in a wound up position. Since the laths 4 are interconnected using the strips of flexible material 6, in order to gain access to the space 16, the curtain 2 can be wound up. There is then no need to remove the curtain 2 from the J-shaped brackets. The laths 4 are easily removed from the U-shaped brackets 12 and the curtain 2 can be wound up. The wind up section of the curtain 2 rests against the U-shaped brackets 12 at a desired height for preventing the curtain 2 from returning to its original extended position. When access to the space 16 is no longer needed, the curtain 2 is wound down.

Referring to FIGS. 8a and 8b, C-shaped brackets 18 can be used to interconnect end to end two or more sections of a curtain 2. The C-shaped brackets 18 are supported by a lath 4, preferably located at a bottom end of a first section 2. To interconnect the first section 2 with a second section 2, a lath 4, preferably located at a bottom end of the second section 2, is inserted within the C-shaped brackets 18.

Referring to FIG. 9, there is shown a plurality of curtain assemblies vertically extending along the peripheral walls of the patio. Articles hidden under the patio, within the space 16, are well hidden from view and protected from bad weather. These curtain assemblies are also protecting against unwanted access to the space 16.

In the preferred embodiment described above, it is worth noting that the support brackets 8, 12, 18 may have any other suitable shapes for providing support to the curtain 2 and the patio could be made entirely of concrete.

While preferred embodiments of this invention have been illustrated in the accompanying drawings and described above, it will be evident to those skilled in the art that changes and modifications may be made therein without departing from the essence of this invention.

1. A windable curtain assembly for a raised dwelling, comprising:
a curtain including:
a series of laths spaced apart from each other;
at least two cords interconnecting the laths together in a parallel relationship; and
a connector to hang the curtain to the raised dwelling constrution, whereby the curtain is windable under the dwelling between a fully extended state and an upwardly wound state to provide access to an area located below the raised dwelling.

2. A windable curtain assembly according to claim 1, wherein said connector comprises at least two J-shaped brackets each having a vertical arm adapted to be connected to the dwelling and a second arm projecting horizontally from the first arm for supporting an uppermost lath of said series of laths.

3. A windable curtain assembly according to claim 1, wherein each of said laths has two opposite ends and the assembly comprises at least one pair of U-shaped brackets including a first and a second U-shaped brackets for attachment respectively to a first and a second vertical support posts supporting the dwelling construction, said ends of any one of said laths being insertable in said U-shaped brackets to keep the curtain in place while it is in the fully extended state.

4. A windable assembly according to claim 3, comprising a plurality of said pair of U-shaped brackets to be distributed over the length of the support posts to provide better support to the curtain along its length.

5. A windable curtain assembly according to claim 1, comprising:
an additional one of said curtain, said additional curtain being hereafter referred to as the second curtain, and said curtain being referred to as the first curtain; and
at least one C-shaped bracket to interconnect end to end said second curtain to said first curtain.

6. A windable curtain assembly according to claim 1, wherein the laths are made of a material selected from the group consisting of wood, plastic, and metal.

7. A windable curtain assembly according to claim 1, wherein the cords are stapled or glued to a back side of the laths.

8. A windable curtain assembly according to claim 1, wherein the cords are nylon strips.
